(19) United States
(12) Patent Application Publication
(10) Pub. No.: US 2016/0356687 A1
(43) Pub. Date: Dec. 8, 2016

(54) GAS DENSITY MONITOR COMPRISING A TRANSMISSION ELEMENT, AND GAS DENSITY MONITORING METHOD

(71) Applicant: Trafag AG, Bubikon (CH)

(72) Inventor: Remo HALBHEER, Hinwil (CH)

(73) Assignee: Trafag AG, Bubikon (CH)

(21) Appl. No.: 15/109,112

(22) PCT Filed: Nov. 24, 2014
(86) PCT No.: PCT/EP2014/075365

§ 371 Date: Jun. 29, 2016

(30) Foreign Application Priority Data
Dec. 31, 2013 (DE) 10 2013 115 007.1

(51) Int. Cl. G01N 9/26

(52) U.S. Cl. CPC G01N 9/266

(57) ABSTRACT

Density monitor for monitoring a gas density in a measuring volume, including a membrane which communicates with the measuring volume in such a way as to move in the measuring volume when a gas density changes, and a membrane movement detection device connected to the membrane, for converting a membrane movement into an electrical signal. The membrane movement detection device is coupled to the membrane by a transmission element for mechanically amplifying the membrane movement path.

### CROSS-REFERENCES TO RELATED APPLICATIONS

This application is the U.S. National Phase of PCT International Application No. PCT/EP2014/075365, filed on Nov. 24, 2014. That application claims priority to German Patent Application No. 10 2013 115 007.1, filed Dec. 31, 2013. The contents of both applications are herein incorporated by reference in their entirety.

### BACKGROUND

Technical Field

The invention relates to a density monitor for monitoring the gas density in a measuring volume, comprising a membrane which communicates with the measuring volume in such a way as to move in the measuring volume when a gas density changes, and a membrane movement detection device, which is connected to the membrane, for converting a movement of the membrane into an electric signal. Such a density monitor is known from DE 10 2010 055 249 A1. The invention also relates to a method for monitoring a gas density, which can be performed using such a density monitor.

Background Art

Regarding the technological background to density monitors, reference is made in particular to JPS5578231A, U.S. Pat. No. 1,527,597 A, U.S. Pat. No. 3,431,785 A, U.S. Pat. No. 6,125,692 A, U.S. Pat. No. 2,662,394 A, U.S. Pat. No. 5,421,190 A, and DE 10232823 A.

Density monitors are measuring devices for monitoring the gas density of a gas to be monitored. As is known from DE 10 210 055 249 A1, density monitors serve in particular for the monitoring of the density in gas-insulated high- and medium-voltage systems or devices such as high-voltage switchgears, converters, pipelines, switching devices, and transformers, as an insulator of an existing gas, for example SF6.

In this connection, density monitors based on electronic measuring principles are known for example from DE 10232823 A1 which are provided with an electronic density sensor as a measuring transducer that includes a piezoelectric crystal arranged in the gas and delivers a frequency signal that is proportional to the density of the gas as a measured value, and the frequency signal is supplied to an electronic evaluation unit.

On the other hand, density monitors based on mechanical measuring principles have become successful on the market because due to their mechanical measuring principle these density monitors are highly reliable and low-maintenance even fora very long time. In the simplest and most frequent case, a membrane working via a reference volume communicates with a measuring volume, and a movement of the membrane caused by a change in the gas density actuates a switch. To this end, in the density monitor known from DE 10 2010 055 249, a membrane of a metal bellows is connected to a switch so that a membrane movement beyond a minimum travel triggers a switching operation.

### BRIEF SUMMARY

It is an object of the present invention to improve a density monitor which is based on a mechanical measuring principle in such a way as to enable the monitoring of a gas density even more accurately and reliably, and this at a greater variety of possible detection principles and a higher degree of freedom in the design of density monitor housings.

This object is achieved with a density monitor according to at least one implementation.

Advantageous embodiments of the invention are the subje atter of other implementations.

In a first aspect, the invention provides a density monitor for monitoring a gas density in a measuring volume, comprising a membrane that communicates with the measuring volume in such a way as to move in the measuring volume when the gas density changes, and a membrane movement detection device connected to the membrane, for converting the movement of the membrane into an electrical signal, characterized in that the membrane movement detection device is coupled to the membrane by means of a transmission element, for mechanically amplifying the membrane movement path.

Preferably, the membrane movement detection device includes a switching device for triggering a switching operation when the membrane moves, and the transmission element is designed for converting the movement of the membrane into a larger switching travel.

Preferably, the transmission element is a lever.

Preferably, the lever is constructed as a single-arm lever.

Preferably, the lever is pivotally supported at a fixed point in a housing of the density monitor on a first end, is coupled to the membrane in an intermediate part, and is coupled to the membrane movement detection device on a second end.

Preferably, the second end is coupled to the switching device, for performing a switching operation when a predefined switching travel is exceeded.

Preferably, the membrane is constructed as a part of a bellows, in particular a metal bellows, wherein the bellows is coupled to the membrane movement detection device by means of the transmission element, for amplifying a bellows movement into a larger movement to be detected.

In a further aspect, the invention provides a density monitor including a lever mechanism.

Preferably, the lever mechanism is constructed for converting a smaller bellows movement of a bellows including a membrane into a larger switching travel for performing a switching operation when the gas density changes beyond a specified value.

By amplifying the membrane movement path, a larger travel for detecting the membrane movement is available. In particular, it is possible to generate a larger switching travel from a smaller membrane movement. This allows the use of even smaller changes in gas density for triggering a switching operation than hitherto. There is also offered a greater design freedom, because the membrane needs not be designed for a maximum movement path.

A lever is particularly preferred as a transmission element and even more particularly a single-arm lever. When such a lever is supported stationary on one end, is coupled to the membrane in the intermediate part, and the membrane movement detection is tapped on the other end, and when a switch is operated in particular, a large switching travel can be achieved with a highly compact design. In particular, a metal bellows such as a stainless steel bellows for forming the membrane can be provided. It is possible in this way to obtain a very reliable and media-compatible, low-maintenance and yet extremely compact and accurate density monitor.

By mechanically amplifying the movement of the membrane, a greater variety of switches can be used. One may even resort to simpler and less expensive switches that require a larger switching travel for being reliably triggered.

A further aspect of the invention herein described relates to the ease of handling and mounting of the density monitor.

To this end, a further aspect of the invention provides a density monitor preferably having a lever mechanism and comprising an overall housing that is divided into a measurement section housing part and a cable connection housing part.

Preferably, the measurement section housing part includes measuring mechanics having a detection device for converting a variable which changes with the gas density into an electrical signal, and a first plug connection element of a plug connection, and the cable connection housing part has a cable connection section and a second plug connection element of a plug connection.

Preferably, one of the plug connection elements comprises several pins and the other one of the plug connection elements comprises several sockets for receiving the pins in a contacting manner.

Preferably, the second plug connection element comprises several cable clamps for connecting strands of a connecting cable which can be contacted with several outputs of the detection device via the pins and sockets.

Preferably, the cable connection housing part is detachably fixed to the measurement section housing part.

Preferably, the cable connection housing part has a cable connection opening for the feedthrough of strands of a connection cable, wherein the cable connection opening is provided with a cable sheath mount for mounting a cable sheath.

Preferably, the cable connection housing part has a plug connection mount or plug connection holder for fixing a plug connection element.

Preferably, the cable connection housing part includes a plug connection element, which has fastening clamps for clamp-fixing strands of a connection cable, and a plug connection area for the plug connection with a corresponding plug connection element on the measurement section housing part.

Preferably, the measurement section housing part includes a circuit board for processing and transmitting electrical signals produced during density detection and includes a circuit board plug connector for the plug connection with a corresponding plug connection element on the cable connection housing part.

Preferably, the density monitor for monitoring a gas density in a measuring volume is equipped with a membrane that communicates with the measuring volume in such a way as to move in the measuring volume when the gas density changes, and with a membrane movement detection device connected to the membrane, for converting a movement of the membrane into an electrical signal, the electrical signal being transferable via a detachable contact connection from the measurement section housing part to the cable connection housing part and there to a cable.

It can also be provided that the measurement section housing part has a housing separation wall for separating the measurement section from a cable connection section.

Preferably, the cable connection housing part is detachably fixed to the measurement housing part.

Preferably, the cable connection housing part includes a cable connection opening for the feedthrough of strands of a connection cable, and the cable connection opening is provided with a cable sheath mount for fixing a cable sheath.

It can also be provided that the cable connection housing part includes a plug mount for mounting a plug connector.

Plug connection elements of a plug connection between the housing parts can be detachably fixed to each other, e.g. by means of a snap connection.

It can also be provided that the connection elements are fixed to each other at their respective housing parts in such a way as to produce an electrical connection for transmitting electrical signals through a cable simultaneously with a suitable mounting of the housing parts to each other. Preferably, the electrical connection is a plug connection.

Instead of plug connections also other electrical connections can be provided, e.g. contact blades, contact pads or the like.

Preferably, a plug connector is provided which includes fastening clamps for clamp-fixing strands of a connection cable, and a plug connection area for the plug connection with a corresponding plug connection element on the measurement section housing part.

A preferred embodiment of the density monitor is designed for monitoring a gas density in a measuring volume and includes a membrane or a separation wall that separates a reference chamber formed in a density monitor housing from the measuring volume.

The measurement section housing part is preferably formed by a density monitor housing, and the cable connection housing part is preferably formed by a plug housing.

The measurement section housing part preferably includes a display for displaying an acquired density value.

By dividing an overall housing into a measurement section housing part, which accommodates the measurement mechanics and its associated elements such as displays or detection devices for generating electrical signals, or also processing electronics, and a cable connection housing part, which accommodates a cable mount and contact elements for connection with cable strands, it is possible to even connect a rather thick and bulky cable to the still separate and easily accessible cable connection housing part in a convenient manner. The measurement section housing part can be conveniently connected even to less accessible measurement points, for connection to a measuring volume without hindrance from a connected cable. Thereafter, the housing parts can be connected to each other. Preferably, positioning aids are provided and particularly preferably an electrical connection, especially a plug connection, is produced simultaneously with the assembly of the housing parts.

All in all, the mounting of a density monitor is considerably simplified and is much more convenient compared to density monitors that have been widely used in practice up to present.

Accordingly, in a further aspect, the invention also provides a mounting method for mounting a density monitor having separate housing parts, the method comprising the steps of:
connecting to a measuring volume to be monitored a measurement section housing part which is provided with measurement mechanics and a detection device for converting a measured variable to be correlated with the gas density to be monitored into an electrical signal and with a first electrical connecting element electrically connected to the detection device, for producing an electrical connection, wherein the measurement section housing part is separate from the cable connection housing part and is mounted without the cable connection housing part,
connecting a cable to the cable connection housing part which is separate from the measurement section housing part and connecting cable strands to contact terminals of a second connecting element provided on the cable connection housing part, for producing the electrical connection,
positioning and fixing the cable connection housing part which is connected to the cable to the measurement section housing part which is connected to the measuring volume while connecting the first connecting element to the second connecting element, in order to produce the electrical connection by mounting the housing parts to each other.

A preferred embodiment of the density monitor is designed for monitoring a gas density in a measuring volume and includes as a membrane a separation wall that separates a reference chamber formed in a density monitor housing from the measuring volume. A path of a movement of the separation wall is amplified via the transmission element and can be tapped at an enlarged scale by a movement detection device, for conversion into an electrical signal.

The transmission element can be any transmission element for movement path amplification, and also a wheel gear or toothed gearing are conceivable. A lever element and particularly a single-arm lever element are preferred, because the same can be a cost-effective, maintenance-free, reliable and room-saving construction.

The movement detection device can be any device for the conversion of a movement into an electrical signal. Pointers or similar mere indicators are not covered by this term. Preferably, a switching device such as a micro switch is provided as a movement detection device.

Preferably, in addition to the movement detection device by which a membrane movement amplified by a transmission element is converted into an electrical signal, the density monitor includes a display, which is also controlled by a movement of the membrane and by which the detected gas density can be displayed.

In a further aspect, the invention provides a method for monitoring a gas density in a measuring volume, the method comprising the steps of:
a) detecting a gas density by means of a separation wall which separates the measuring volume from a reference volume,
b) amplifying a movement path of the separation wall by means of a transmission element,
c) converting the amplified movement path into an electrical signal.

It is preferred for step b) to include: transmitting the movement path by means of a single-arm lever.

It is preferred for step b) to include:
amplifying the movement path into a larger switching travel,
   and for step c) to include:
performing the switching operation by means of a switching device when a predefined switching travel is exceeded.

### BRIEF DESCRIPTION OF THE DRAWINGS

An embodiment of the invention will be described in more detail with reference to the attached drawings wherein it is shown by

FIG. 1 a schematic cut-open illustration of an embodiment of a density monitor in a disassembled condition prior to mounting;

FIG. 2 an illustration similar to FIG. 1 in the assembled state and mounted at the point of use; and

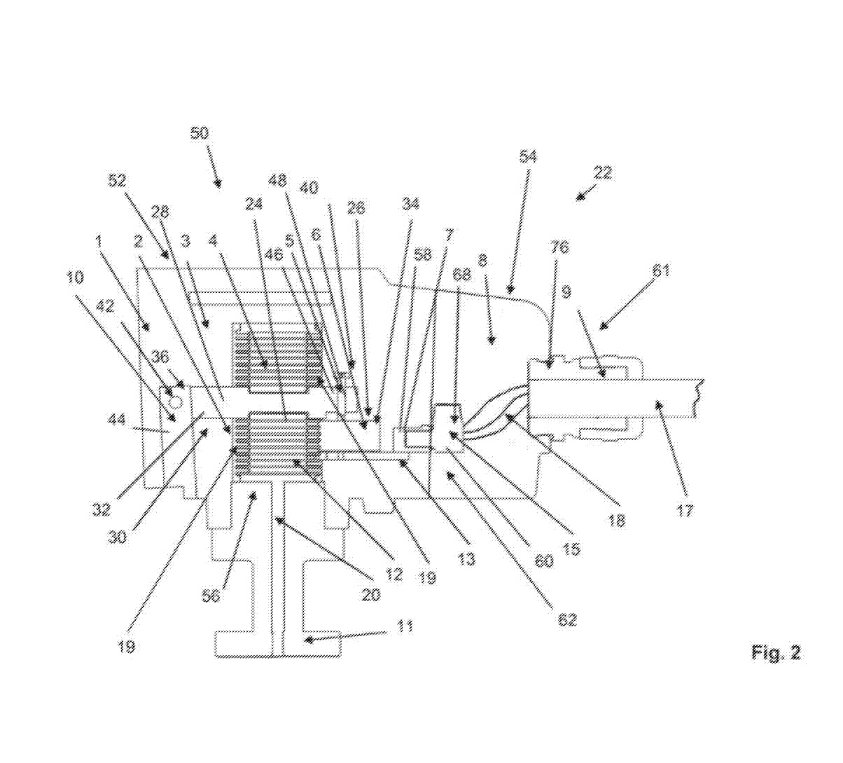

FIG. 3 a schematic cut-open planar view of the density monitor of FIG. 2.

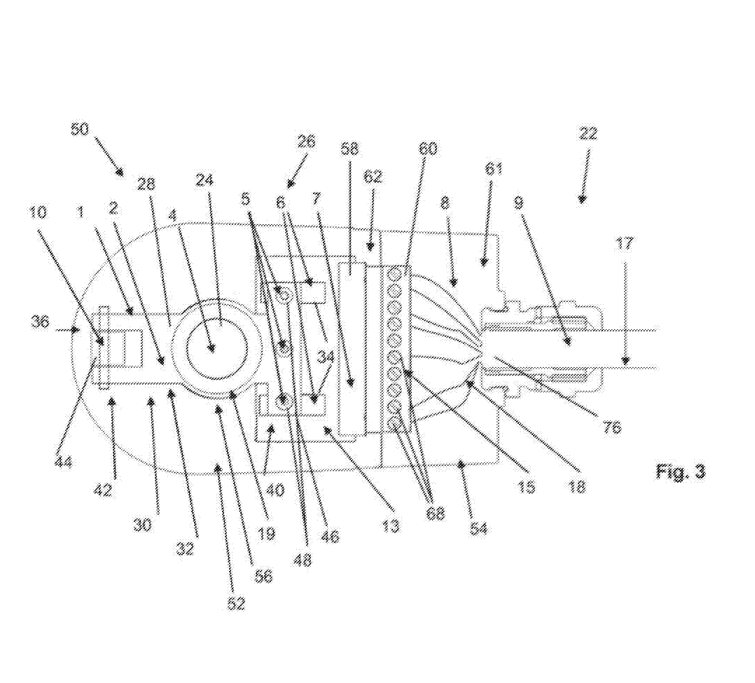

### DETAILED DESCRIPTION

In the Figures, an embodiment of a density monitor 22 is shown. The density monitor 22 is designed for monitoring a gas density in a measuring volume. The density monitor 22 is provided with an overall housing 50, which is divided into a measurement section housing part 52 and a cable connection housing part 54.

The measurement section housing part 52 accommodates measurement mechanics 52 with a detection device 26, for converting a variable changing with the gas density into an electrical signal, and a first plug connection element 58 of a plug connection 62.

The cable connection housing part 54 accommodates a cable connection area 61 and a second plug connection element 60 of the plug connection 62.

One of the plug connection elements 58, 60 comprises several pins 64 and the other one of the plug connection elements 58, 60 comprises several sockets 66 for receiving the pins 64 in a contacting manner. The pins 64 and sockets 66 are examples of contact terminals for producing electrical connections for several different lines for conducting electrical signals.

The second plug connection element 60 comprises several cable clamp holders 68 for the clamping connection of strands 18 of a connecting cable—cable 17—which can be contacted with different outputs of the detection device 26 via the pins 64 and sockets 66.

The cable connection housing part 54 is detachably fixed to the measurement section housing part 52 in a mutually defined position via screw connections 70 with positioning aids 72.

The cable connection housing part 54 includes a through hole, for the feedthrough of strands 18 of the cable 17, the through hole 76 being provided with a cable sheath mount—particularly a threaded cable connection 9—for fixing a cable sheath.

The cable connection housing part 54 includes a plug connection mount 74—which particularly includes at least one fastening screw 14—for fastening the second plug connection element 60.

The cable connection housing part 54 includes the second plug connection element 60 which comprises fastening clamps for clamping the strands 18 of the cable 17, and a plug connection area for a plug connection with the corresponding first plug connection element 58 on the measurement section housing part 52.

The measurement section housing part 52 includes a circuit board 13 having components for generating, processing and/or transmitting electrical signals generated during the detection of the density, and a circuit board plug connector 7 as a first plug connection element 58 for the plug connection with the corresponding second plug connection element 60 on the cable connection housing part 54.

In the illustrated embodiment, the overall housing 50 of the density monitor 22 is divided into the measurement section housing part 52 in the form of a density monitor housing 1 and the cable connection housing part 54 in the form of a plug housing 8.

For monitoring a gas density in a measuring volume, the density monitor 22 is equipped with a membrane 24 which communicates with the measuring volume in such a way as to move in the measuring volume when the gas density changes, and is equipped with the detection device in the form of a membrane movement detection device 26 connected to the membrane 24, for converting a movement of the membrane into an electrical signal, wherein the electrical signal can be transmitted from the measurement section housing part 52 to the cable connection housing part 54 and there to the cable 17, via a detachable electrical connection, in particular a plug connection 62.

Accordingly, the density monitor 22 includes a separation wall or membrane 24 which communicates with the measuring volume in such a way as to move in the measuring volume when a gas density changes. Further, the membrane movement detection device 26 connected to the membrane is provided for converting a membrane movement into an electrical signal. The membrane movement detection device 26 is coupled to the membrane 24 by means of a transmission element 28. The transmission element 28 is designed in such a as to amplify the membrane movement path. The membrane movement detection device 26 taps the path amplified by means of the transmission element 28 and uses the same for generating an electrical signal.

In the preferred embodiment as illustrated, a lever mechanism 30 comprising a lever 32 as a transmission element 28 is provided for implementing the transmission element 28.

The lever is constructed as a single-arm lever 32. To this end, the lever 32 is supported at a fixed point relative to the density monitor housing 1 in a lever bearing 38 on a first end 36. With an intermediate part, the lever 32 is articulated to the membrane 24. On its free second end 40, the lever 32 engages at the membrane movement detection device 26.

Preferably, the membrane movement detection device 26 is a switching device 34 for performing a switching operation in the event that the gas density changes by a predefined value. In particular, the switching device 34 generates a warning signal in the event that the gas density changes by more than a tolerance value.

In this embodiment, the lever 32 is exclusively or essentially provided for performing a switching operation. Accordingly, it can be referred to as a switching lever 2.

In addition, a display 3 is provided on which the detected gas density value can be displayed. This display is provided on the measurement section housing part 52 and is connected to the measurement mechanics 56, in particular to at least one bellows 12, 19.

This measurement mechanics 56, which is situated in the density monitor housing 1, will be discussed in more detail below. The membrane 24 is formed as a separation wall in or on at least one bellows 12, which is in the form of at least one metal bellows 19. The metal bellows 19 includes a reference chamber 4 forming a reference volume. The membrane 24 separates the reference chamber 4 from a measuring volume.

To this end, a pressure connection 11 is provided with which the density monitor 22 is connected to a switching system (not illustrated) or a similar installation to be monitored and which includes a passage for the gas to be monitored. In the illustrated example, the switching system gas 20 is supplied through the pressure connection 11 to a further chamber 21 in the bellows 12, 19. This further chamber 21 is separated from the reference chamber 4 by the membrane 24. An implementation with two bellows 12, 19 is also possible, wherein one bellows 19 includes the reference chamber 4 and the other bellows 12 contains the switching system gas 20. In this case, the lever 32 can be provided between the two bellows 12, 19 which are biased against each other and which work against each other.

In an implementation with double bellows 12, 19 which are divided into two chambers 4, 21 by the separation wall or membrane, the lever 32 engages around the central part of the metal bellows 19 which is provided with the membrane 24 as a separation wall, and is connected to this central part so that the lever is driven by a movement of the central part of the bellows 12, 19.

In the illustrated embodiment, the lever 32 is constructed as a switching lever 2. On the density monitor housing 1 a bearing 42 for the first end 36 of the switching lever 2 is formed stationary with respect to the housing so that a switching lever joint 10 is formed.

In this specific embodiment, the bearing 42 has a central protruding flange 44 with a through opening for a bearing pin. The first end 36 is bifurcated and engages around the flange 44 and is also provided with a corresponding through opening for the bearing pin.

The central part of the switching lever 2 has a ring portion for engaging around the metal bellows 19.

The second end 40 includes a crossbar 46 in which several openings 48 are provided which are penetrated by adjustment screws 5. The openings 48 have a larger diameter than the shaft portion of the adjustment screws 5.

The adjustments screws 5 are effective as a tappet for actuating the switching device 34 and can be screwed in or screwed out in order to adjust the switching travel.

Several switching devices 34 can be actuated by the second end 40, as illustrated. In the described embodiment, at least two micro switches 6 are provided that can be actuated by the switching lever 2. Different switching travels can be set here by means of the adjustment screws 5 so that the micro switches 6 each perform switching operations at different gas density values. Even a third micro switch (not shown) can be actuated by the intermediate adjustment screw 5.

The switching device 34 that is formed by the several micro switches 6 is fixed on the circuit board 13, which detects the switching operations of the micro switches 6 and transmits the corresponding electrical signals of the switching operations to contact terminals such as the pins 64 in the circuit board plug connector 7, which forms the first plug connection element 58.

Instead of the third micro switch another sensor (not shown) can be provided on the circuit board which produces a signal which represents a measure for the position of the lever 32 and which changes with the position of the lever 32. This position signal can be used for example for remotely displaying the current density value. This signal, which represents the current density value, is also transmitted to one of the contact terminals—one of the pins 64—of the first plug connection element 58.

The circuit board plug connector 7 is one example of the first plug connection element 58 on the measurement section housing part 52. On the cable connection housing part 54 formed by the plug housing 8, the second plug connection element 60 having fastening clamps for clamping strands 18 of the cable 17 and having a plug connection area for a plug connection with the corresponding first plug connection element 58 of the measurement section housing part 52 is provided.

The plug connection element 60 on the plug housing 8 includes for example a cable clamp 15 having small clamping screws so that the individual strands 18 of the cable 17 can be fixed in the cable clamp 15. Further, the plug connection area is provided, which can be plug-fitted in the plug connection area of the circuit board plug connector 7 and which can be designed, where appropriate, also for fastening by means of a latching mechanism or the like.

In the illustrated embodiment, the cable connection housing part 54 formed by the plug housing 8 further includes a plug connection mount 74 implemented by fastening screws 14 for fastening the cable clamp 15. In this implementation, a latching mechanism is preferably not provided.

The plug housing 8 can be fixed to the density monitor housing 1 by means of a threaded dome 16 which is formed so as to protrude from the density monitor housing 1. The threaded dome 16 is part of the screw connection 70 and also forms one of the positioning aids 72.

The cable connection housing part 52 formed by the plug housing 8 further includes a through hole 76 for the strands 18. On the through hole 76 a cable gland 9 is provided as an example of a cable sheath mount for fixing a cable sheath of the cable 17.

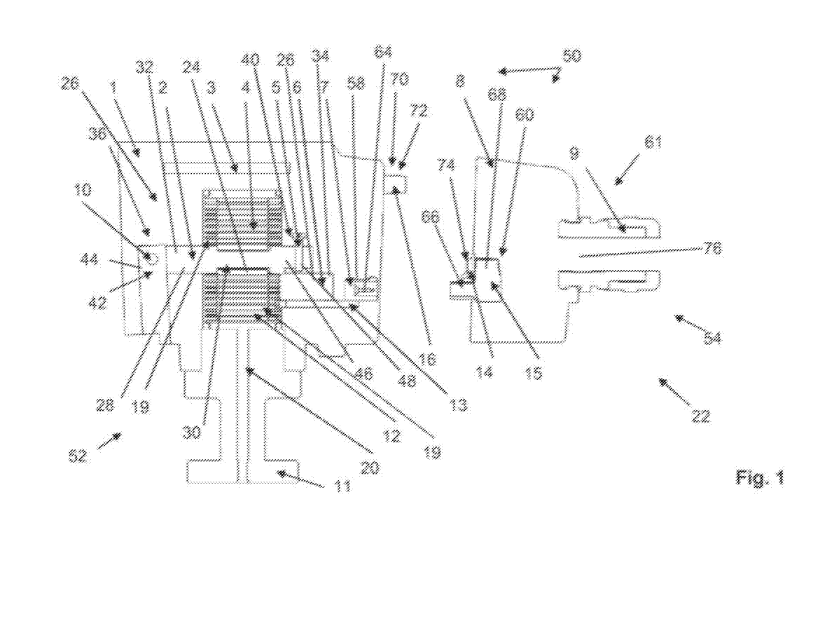

As shown in FIG. 1, the cable connection housing part 54 can be removed from the actual density monitor housing 1 so that the cable 17 and the strands 18 can be easily connected to the cable clamps 15 and to the cable gland 9 even if the density monitor housing 1 is already mounted. The cables of density monitors are often rather thick and bulky so that this design considerably facilitates work during mounting.

Thereafter, the cable connection housing part—which in the present case is formed by the plug housing 8—together with the connected cable 17 can be passed to the density monitor housing 1 and can be fixed there by means of he threaded dome 16. To this end, in an embodiment not further shown, a cable clamp 15 to which strands 18 are clamped and which is loosely arranged in the plug housing 8, can be inserted and, where appropriate, locked in the circuit board plug connector 7, and the plug housing 8 is mounted and fixed only after that step. In the illustrated embodiment, the cable clamp 15 is already suitably fixed to the plug housing 8 by means of the plug connection mount 74 so that the plug connection 62 is produced simultaneously with attaching and fixing the plug housing 8 to the density monitor housing 1.

### LIST OF REFERENCE NUMBERS

1 density monitor housing

2 switching lever

3 display

4 reference chamber (reference gas volume)

5 adjustment screw (tappet)

6 micro switch

7 circuit board plug connector

8 plug housing

9 cable gland

10 switching lever joint

11 pressure connection

12 bellows of switching system gas

13 circuit board

14 fastening screw of cable clamp

15 cable clamp

16 threaded dome for fixing the plug housing

17 cable

18 strands

19 metal bellows

20 switching system gas

21 chamber (in communication with measuring volume)

22 density monitor

24 membrane

26 membrane movement detection device

28 transmission element

30 lever mechanism

32 single-arm lever

34 switching device

36 first end

40 second end

42 bearing

44 flange

46 crossbar

48 opening

50 overall housing

52 measurement section housing part

54 cable connection housing part

56 measuring mechanics

58 first plug connection element

60 second plug connection element

61 cable connection section

62 plug connection

64 pin

65 socket

68 cable clamp holder

70 screw connection of housing parts

72 positioning aid

74 plug connection mount

76 through hole for strands

1. Density monitor for monitoring a gas density in a measuring volume, comprising
a membrane which communicates with the measuring volume in such a way as to move in the measuring volume when a gas density changes, and
a membrane movement detection device connected to the membrane, for converting a membrane movement into an electrical signal,
characterized in that the membrane movement detection device is coupled to the membrane by means of a transmission element for mechanically amplifying the membrane movement path.

2. Density monitor according to claim 1, characterized in that the membrane movement detection device includes a switching device for triggering a switching operation when the membrane moves, and that the transmission element is designed for converting the membrane movement into a larger switching travel.

3. Density monitor according to claim 1, characterized in that the transmission element is a lever.

4. Density monitor according to claim 3, characterized in that the lever is designed as a single-arm lever.

5. Density monitor according to claim 4, characterized in that the lever is pivotally supported at a fixed point in a housing of the density monitor on a first end, is coupled to the membrane in an intermediate part, and is coupled to the membrane movement detection device on the second end.

6. Density monitor according to claim 5, characterized in that the second end is coupled to the switching device, for performing a switching operation when a predefined switching travel is exceeded.

7. Density monitor according to claim 6, characterized in that the predefined switching travel is adjustable.

8. Density monitor according to claim 1, characterized in that the membrane is constructed as a part of a bellows, in particular a metal bellows, wherein the bellows is coupled to the membrane movement detection device by means of the transmission element, for amplifying a bellows movement into a larger movement to be detected.

9. Density monitor with a lever mechanism.

10. Density monitor according to claim 8, characterized in that the lever mechanism, is designed for converting a smaller bellows movement of a bellows having a membrane into a larger switching movement, for performing a switching operation when the gas density changes beyond a predefined value.

11. Method for monitoring a gas density in a measuring volume, the method comprising:
a) detecting a gas density by means of a separation wall, which separates the measuring volume from a reference volume,
b) amplifying a movement path of the separation wall by means of a transmission element, and
c) converting the enlarged movement path into an electrical signal.

12. Method according to claim 11, characterized in that step b) includes:
transmitting and amplifying the movement path by means of a single-arm lever.

13. Method according to claim 11, characterized in that step b) includes:
amplifying the movement path into a larger switching travel, and
that step c) includes:
performing a switching operation by means of a switching device when a predefined switching travel is exceeded.
